(19) United States
(12) Patent Application Publication
(10) Pub. No.: US 2003/0236847 A1
(43) Pub. Date: Dec. 25, 2003

(54) Technology enhanced communication authorization system

(76) Inventors: Joseph C. Benowitz, Salt Lake City, UT (US); Kyle J. Bunch, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/465,245

(22) Filed: Jun. 19, 2003

Related U.S. Application Data
(60) Provisional application No. 60/390,425, filed on Jun. 19, 2002.

(51) Int. Cl. H04L 9/00; H04L 9/32; G06F 11/30; G06F 15/16

(52) U.S. Cl. 709/206; 713/202

(57) ABSTRACT

A method of authorizing communications includes receiving a communication from a sender, determining if the communication contains a valid authorization code, notifying the sender if a valid authorization code is not detected with instructions on obtaining a valid authorization code and providing the sender with a service for obtaining a valid authorization code in order to resend the communication with the valid authorization code. The method of authorizing communications also includes forwarding the communication to a recipient if a valid authorization code is detected and holding the communication in an unauthorized box if a valid authorization code is not detected.

### CROOSS-REFERENCE OF THE RELATED APPLICATION

The present invention claims priority to U.S. Provisional Patent Application Serial No. 60/390,425 filed on Jun. 19, 2002, hereby incorporated by this reference.

### BACKGROUND OF THE INVENTION

1. Field of the Invention

The present invention relates generally to a communication control and management system, and more specifically to methods for controlling incoming communications such as electronic mail (“email”) to limit receipt of unsolicited communications and/or unwanted communications from vendors, entities or individuals while retaining the ability to receive desired communications. The present invention also relates to methods for obtaining passwords, codes or unique addresses used in limiting receipt of such unwanted or unsolicited communications to allow a system according to the present invention to allow receipt of communications from potentially desirable senders.

2. Description of the Prior Art

Internet usage as a means of communication is common worldwide. The number of individuals and entities using the Internet as a means of communication grows daily. With this growth has come an actual dependence upon this relatively new form of communication. The dependence is based primarily on both the ease and inexpense of Internet usage. Users may communicate, via the Internet, worldwide with minimal cost, in comparison to other more traditional forms of communication such as mail, phone and facsimile.

Some businesses use the Internet to communicate information regarding products or services with consumers. Due to the relative ease and affordability of sending promotional material via email, however, consumers have been flooded by unsolicited and unwanted, promotional email messages. In addition, while many email messages from certain entities may have at one time been desired, they later become undesirable. At a point where email from a particular sender becomes unwanted, it is often difficult for the user to remove their email address from the sender, if for example, an unsubscribe option is not provided by the sender. In addition, even when an unsubscribe option is provided by a spammer, clicking on it merely verifies that the receiver's email is valid, potentially resulting in even more unwanted email.

The receipt of such unsolicited email is disadvantageous for many reasons. Unwanted email can occupy significant server space, resulting in slower networks and decreased performance. In addition, unsolicited email forces the user to waste time by either reading or at least identifying the email as “junk” mail and deleting the email from the system. The receipt of a host of such unsolicited email, commonly referred to as “spam,” can quickly overwhelm a user's and email system. This is especially the case if senders of such spam have improper motives of harming or annoying recipients, thus effectively using spam as a means to cripple, harass and/or annoy. Moreover, with the increase in use of mobile telephones to access ones email and thus incurring airtime charges to do so, as well as separate tolls to access the Internet, downloading of spam can become quite expensive.

Various attempts have been made in the art to protect users from such unsolicited email or spam. Some of the earlier attempts at blocking spam having generally included various filters aimed at determining whether an incoming email is desirable or not. For example, such attempts have included such measures as requiring the user to house a list of acceptable email addresses to which an address of the sender of an incoming email is compared. If the sender's address is not on the list of acceptable email addresses, the email is either deleted or the receiver is prompted to determine whether to accept or reject the incoming email. Such a system, however, may result in desired email messages being deleted. In addition, such a system may waste the time of the recipient by requiring the recipient to at least view the email address and/or the subject line of the incoming email to determine whether the email is desired.

Likewise, various filters have been provided that attempt to search the content of incoming email to determine if certain words or phrases are contained in the email message. Such logic systems, however, may block desirable email that includes a particular word or phrase contained in the filter. In addition, the recipient may still be required to view certain portions, such as the sender's email address and subject line, to determine whether the incoming email should be deleted. Such systems, therefore, rely on the recipient to manually screen incoming email.

One specific attempt in the art aimed at reducing the recipient's involvement in screening incoming email is disclosed in U.S. Pat. No. 6,199,102 to Cobb. The method includes receiving a message from a sender, comparing the address of the sender to a list of acceptable senders, sending a challenge back to the sender if the sender's email address is not on the list of approved senders, waiting for a response to the challenge, and determining if the response to the challenge is a proper response. The sender is thus required to answer the challenge in order for the email message to be sent to the user. If the correct answer is entered, the system allows the email message to pass through to the intended recipient. (Such challenge/response schemes have been known for quite some time and were disclosed in a public-domain Perl script.) Because most spammers use automated emailing systems, the theory is that such automated systems would not be able to answer the challenge. Thus, email generated by such automated systems would effectively be blocked when a response to the challenge is not received. Such a system has obvious limitations and drawbacks including, for example, once an email address makes its way onto the receiver's list of approved addresses, the receiver will continuously receive email from that address, even if it turns out that the email address is from a spammer. In addition, spammers have begun hiring actual people to respond to such challenges in order to get their email message through to the recipient and it is likely only a matter of time before the automated email sending system is configured to automatically respond to such challenges. In such a system, once an address is approved, it is simple for this address to be sold to spammers. The return addresses of email addresses are frequently forged, so once an address is approved, any spammer can use it.

A similar method is disclosed in U.S. Pat. No. 6,112,227 to Heiner. In Heiner, the method includes the steps of receiving an email message, comparing the email address of the sender to an accepted list of email addresses, sending a reply email message to the sender requesting that the sender complete a registration process when the email address of the sender is not on the list of accepted email addresses, monitoring the response from the sender to determine if the sender properly responds to the registration request, and sending the email to the intended recipient only if the sender properly responds to the registration request. Again, such a system has obvious limitations similar to those mentioned with reference to the Cobb reference. In addition, like the previous method, the email is accepted based upon the sender's email address and thus requires the receiver to create and maintain a potentially large database of acceptable email addresses. This method also has the same problem that the return address can be forged. Further, once the address is passed around, there is no way to stop the spam short of the sender changing his/her email address.

Yet another attempt at blocking spam is disclosed in U.S. Pat. No. 6,266,692 to Greenstein. Greenstein involves providing a passcode to those potential email senders from whom a particular recipient will accept email. The passcode must be entered into the “header” of the email by the sender. When an email message is received, the email system checks in the header for a valid passcode. If a valid passcode is present, the email passes through the system to the recipient. If, however, an invalid passcode is received or no passcode at all, the system responds by either deleting the incoming email or by placing the email in a temporary folder until rejected email messages can be reviewed by the intended recipient. In order for the system to operate, however, it requires that a separate field be created for providing and receiving the passcode. Thus, the system is not usable with existing email systems. In addition, once a passcode is obtained by a spammer, an email recipient would continue to receive spam. Furthermore, there is no way for a sender to obtain a passcode electronically or without contacting the intended recipient. Moreover, the system does not notify the recipient of a message is deleted because it lacked a code. Thus, a legitimate sender will not know if their message was rejected. Also, the system forces the recipient to review all spam to ensure that legitimate mail is not deleted that may have been received without a passcode.

Therefore, it is desirable to provide a method for stopping unsolicited communications such as email, marketing email and other unwanted email (i.e., “spam”) from vendors and other various senders that does not require the receiver's input, that does not necessarily require modification of existing systems, and that is virtually impossible for those sending spam to circumvent, while retaining the ability to receive important or desired communications, to obtain password updates from web sites, and obtain email from service providers when desired. Also desirable would be the ability to dynamically block spammers once the system is compromised. Thus, it would be further desirable to provide dynamic email addresses that can be controllable by the receiver to prevent receipt of spam in an email system..

### SUMMARY OF THE INVENTION

Accordingly, the present invention relates to a communication authorization system (hereinafter “CAS”). The CAS of the present invention has application in various forms of communication, including without limitation, communications which are exchanged between two or more parties through any device that transfers a message from one location to another using electricity, through electromagnetic waves, including without limitation, radio waves, microwave, light waves, x-rays and so on, fiber optics or any other method or means that aids transmission of communications. Examples include, but are not limited to telephone communications, facsimiles, cell phone communications, radio communications as well as computer communications. The present invention, however, has particular applicability with computer-based communications in the form of electronic mail (hereinafter “email”), as well as instant messaging, peer-to-peer networking, streaming audio, streaming video and any other information transmitted over local and wide area networks, virtual networks and the Internet.

When automated, a CAS according to the present invention would have particular applicability to peer-to-peer networks. For example, a peer-to-peer network, such as Gnutella, where people share files directly between computers, such as music files or other types of files, provide a simple path for viruses to be passed. The CAS allows control over who has access to your computer on a peer-to-peer network, as well as similarly configured communication channels. The use of the CAS of the present invention on peer-to-peer networks can also allow file sharers to control distribution of files and create charges for file sharing or distribution. Likewise, the CAS could prevent spammers from interrupting instant messaging sessions.

A CAS according to the present invention may be employed by utilizing virtually any form of communication equipment that is used to transmit a message from one party to another. Such equipment includes all devices, including all peripheral devices, that when properly organized in conjunction with one another, enable transmission of a message. When the CAS receives an incoming message from any individual or entity by any device capable of sending such a message to a system capable of receiving such a message, the CAS checks for a proper communication authorization code or recipient address containing a proper communication authorization code. The authorization code may comprise any code, including without limitation numeric, alphanumeric, binary, or other codes known in the art in the form of an identifier, digital signature or password that is entered by the recipient into the CAS (or generated by the CAS) so that the CAS can determine whether an incoming communication should be allowed to reach the intended recipient. Such authorization codes may be received by the CAS manually, electronically, through voice recognition or through any other interface that provides the authorization code to the CAS. In addition, the authorization code may be received by the CAS simultaneously with the communication itself or separate and apart from the communication. Thus, the authorization code may be entered in a format that is separate from the communication, as part of the communication, as part of the communication process, embedded in the communication, as an electronic attachment or an attached file. In addition the authorization code may or may not be encrypted and can be broken up into various pieces or components, with the various pieces placed in different locations within the email.

An authorization code may be transmitted to the recipient with a message from the sender by any method that transfers the authorization code, including but not limited to voice recognition, data entry, facsimile, telephone keypad, magnetic strip, email, as an attachment to an email, as an encrypted attachment to an email, embedded in the address of the intended recipient, embedded in the message of the communication itself, embedded in the package containing the communication or any other method that accomplishes the transfer of the authorization code to a CAS according to the present invention.

In one particular embodiment, the authorization code is at least part of the email address of the recipient. Thus, for example, the recipient may provide authorization codes to various potential senders with instructions to insert the code into the email address of the recipient. As such, incoming email messages for a particular recipient could include a variable portion to contain an authorization code and a static portion which includes the recipient's common email address to allow the email system of the recipient to properly route the email message to the intended recipient. This creates a dynamic email address for the recipient that can be altered at any time by the recipient to effectively control incoming email. This is a particularly useful way to control incoming email since embedding the code in the actual email address of the user allows CAS to be used with all existing email systems. The authorization codes may be transferred, conveyed or provided to a potential sender via various methods.

In another embodiment, a CAS according to the present invention includes a method of creating separate email addresses to perform the same function as the dynamic email address (different codes+email address) described above. The CAS could be implemented by simply creating a new email address that serves the same function. Here, though, the email addresses are changed on the email server so that the server can properly route the emails, and each recipient would likely have access to more than one email account for each email address assigned to that recipient.

In another embodiment of the present invention, separate external and internal authorization codes are provided. The internal authorization codes may be a special form of an authorization code for use internally, for example, to a corporation or other organization. The internal authorization code may define when, how and to whom a message may be sent by a sender and when, how and from whom an intended receiver may receive a message. In addition, such internal authorization codes may be used in conjunction with an external authorization code. Because the internal authorization and external authorization codes are particular forms of an authorization code in accordance with the principles of the present invention, the term “authorization code” may include internal and/or external authorization codes, if relevant and applicable to the context.

A CAS according to the present invention includes a system for managing authorization codes and system for determining whether an incoming communication contains a proper or acceptable authorization code. If the code is acceptable, the communication passes through to the intended recipient. if the code is unacceptable, the CAS provides the sender with one or more options for obtaining an acceptable authorization code. Such a system for managing and providing authorization codes may be part of the CAS or an independent system that accompanies the CAS.

A CAS according to the present invention may also include an authorization process for determining an appropriate action for the CAS when receiving a communication with an authorization code or no authorization code. Thus, the system may provide a user interface for the sender of a communication for obtaining a proper authorization code as well as instructions and conditions for using the CAS. In addition, the CAS may include a user interface for the receiving user to interact with the CAS for changing, deleting or adding authorization codes, change addressing methods, and receiving instructions on using the systems and conditions for using the CAS.

For example, a CAS according to the present invention may provide a notice upon receipt of an invalid or non-existent authorization code in an incoming communication. Such a notice may take any form, including but not limited to, a voice message, an email, a facsimile, person-to-person communication or any form of computer-generated communication.

Such a notice may be provided by a notification service, which is an administrative system managing the transmission and routing of the notification. The notification service may be a manual process, an automated process, a computer or electronic process or any other process that accomplishes the same task. A notice request is a request sent by the CAS to the notification service to instruct the notification service to issue a notice if the CAS determines that an authorization code accompanying a communication is not on the exempt list. The exclusion list is a database that may be maintained on the receiver's end, contained within the CAS, maintained by the notification system and/or resident on an independent basis.

In an exclusion list according to the present invention, the sender is exempt from going through any authorization or filtering process. All other emails received go through the authorization process and are placed in the unauthorized mail box if they do not have a proper authorization code. In filtering systems known in the art, those who are not on the approved list (also known as a “white list”) can still end up in the receiver's inbox because such filter systems may inadvertently allow spam to pass through the filter. Further, legitimate mail coming from those not contained on the white list can be incorrectly deleted or placed in a junk mail folder. Accordingly, a CAS according to the present invention including an exclusion list results in no unwanted email in a receiver's inbox, assuming someone has not stolen an authorization code and email address and the receiver has not changed the authorization code. Conversely, in conventional filtering systems, spam can still end up in a receiver's inbox.

A system maintaining the exclusion list may be provided with the capability of categorizing the authorization codes to allow the receiver or receiving technology to handle incoming communications in various ways depending upon the category of authorization code received and/or to instruct the CAS according to the particular authorization code or category of authorization code received. For example, in certain instances, a user of the CAS receiving communications through the CAS may want all communications from a particular individual or entity regardless of whether or not the particular individual or entity provides an authorization code. Thus, the system may provide an exclusion list for containing names, addresses or other unique identifiers of particular individuals or entities that are acceptable by the CAS without a proper authorization code.

In addition, a CAS according to the present invention may provide hierarchical control of authorization codes which define rules under which a communication from a sender may be sent to a particular intended receiver thus allowing an administrator of a CAS according to the present invention to enable an organizationally desired communication system while blocking undesired communications.

Moreover, a CAS according to the present invention could be configured to track code usage to limit usage of a particular code to a certain number of email messages, or to ban certain individuals from obtaining additional codes. When an authorization code is issued, the CAS can tie the code to the particular user either by tracking the code and email address and/or IP address of the sender. By such tracking, the system can monitor code usage by particular users in order to determine whether certain users have shared their codes or whether certain users are violating the usage terms of the codes.

Furthermore, a CAS according to the present invention can track a sender by IP address or MAC address (i.e., the identifying address of a card connected to a network) to limit a particular computer to get a limited number of authorization codes within a certain time period. Thus, while the CAS of the present invention can force a sender to wait for a valid authorization code in order to discourage spamming, the CAS can also track individual senders to determine how many individual requests for codes a particular computer is making. By limiting the number of codes a particular computer can get at a time or in a predetermined period of time (through tracking of IP address, MAC address or some other unique identifier), such abuses of the system can be prevented. Thus, the CAS can limit a sender to obtaining a certain number of authorization codes within a given time period.

A CAS according to the present invention may also provide miscellaneous authorization codes that include any information sent with the authorization code for purposes other than authorization.

Other types of authorization codes may include authorization codes for restricted use, which is an authorization code valid for restricted use only, providing limited communication between the sender and receiver. Examples of restricted uses include, but are not limited to, single use, limited time use, limited number of communications use, limited communication size use, and other restrictions. Furthermore, codes could be administered by parents with the parents copied on all incoming email to ensure child safety.

A CAS according to the present invention may also include an authorization code box that receives the notice and makes the notice available to the sender. The box may be a physical structure, similar to a mailbox, or an electronic structure, such as a voicemail box, an email box, a pager message, a pager mailbox or any other method in which a notice can be received and made available to a sender.

An authorized communication inbox may also be provided that receives communications containing valid authorization codes for a particular intended recipient or communications from senders that are provided on an exclusion list.

Likewise, a CAS according to the present invention may also include an unauthorized communication inbox for receiving and maintaining communications that have been rejected by the CAS, either because an invalid authorization code was provided or because no authorization code was received at all and the sender was not listed on the exclusion list. The CAS provides the intended recipient with the option to access such unauthorized communications, should the intended recipient choose to access the unauthorized communication inbox to determine whether any of the rejected communications are desired messages. As an option, the CAS can automatically delete such communications after a predetermined period of time (i.e., a timed purge) or perform any other function chosen by the intended recipient.

A CAS according to the present invention may provide usage terms under which a recipient user must agree in order to use the CAS. In addition, separate usage terms may be provided to senders that senders must agree to and abide by as a condition for use of the CAS. Such usage terms may include and define acceptable use of the system, penalties for failing to abide by the usage terms and specific remedies for failure to comply with such usage terms. In an email setting, the purpose of such usage terms for senders is to discourage spammers from sending communications to a particular address by making the usage terms commercially disadvantageous to the spammer.

There are other methods that can be employed to discourage spammers. For example, in another embodiment, one method of discouraging a spammer from waiting for a proper authorization code to accompany a given communication is for a CAS according to the present invention to return a message to the same address from which the message originated containing a proper authorization code. Such a reply, however, may be delayed by a predetermined period of time. The delay would be selected so as to be sufficiently long such that waiting for the authorization code would be commercially disadvantageous.

Another delay that can be employed to discourage spammers is to delay validation or activation of the authorization code. Thus, while the spammer will promptly receive notification that an authorization code needs to be obtained, and the spammer can immediately request the authorization code, the CAS could delay receipt of the authorization code by the spammer or, in the alternative, the authorization code would not be recognized by the CAS as valid or active until a period of time has elapsed from the time that the authorization code was obtained. Likewise, the system requesting the authorization code could be tied up for a specified period of time. Thus, the computer or system would connect to the authorization system, request the code, and be informed that the connection must remain open for a specific time before the code is provided. A timer may even count down the time period needed to wait before receiving the code. Further, a limited number of codes requested by the computer or system may be provided within any specified period of time.

In another embodiment, the request for an authorization code according to the present invention may also provide a way for the user of the CAS to track the computer or system requesting the authorization code so that the issued authorization code can be linked to a particular computer or system in order to track usage of the code by computer or system rather than by email address alone. Thus, when a request is made via a network or web, such as the Internet, the CAS will read and track the IP or MAC address of the user along with the specifically issued authorization code to that user.

Another method of discouraging a spammer from sending unsolicited email is to require a fee for transmission of the authorization code. Likewise, a fee could be charged for transmission of an email within the CAS system.

Most spammers do not want to incur a fee, even a small fee, with each email message sent.

An important aspect of the CAS of the present invention is that a sender can only obtain a limited number of authorization codes within a particular time period or one authorization code at a time, as determined by the user. It was mentioned previously that the CAS can tie the authorization code to the particular user either by tracking the code and email address and/or IP address of the sender. Thus, the spammer could not simply repeat the process of obtaining an authorization code each time that spam was rejected. The spammer would have to associate the receiver's email address with an authorization code each time that an email was sent.

A CAS of the present invention also includes various “non-system” communications between senders and receivers. For example, a receiver may be desirous of circumventing the CAS when engaging in communication utilizing such services as direct peer-to-peer communication. Herein, the use of peer-to-peer communication can be direct communication between people, or more traditionally in a computer context, direct communication between computers with no intermediate server.

A CAS according to the present invention includes an authorization process for determining the proper handling of a communication. For those communications containing a valid authorization code, the authorization code itself may be used to direct the CAS to take a particular action.

In one embodiment of the present invention in which email is the chosen form of communication, the CAS provides a method that will allow a recipient user to choose and enforce whether a particular sender will be able to transmit a communication to the user receiver, thereby providing the recipient with a right to choose which communications are received and under what conditions they will be accepted, while retaining methods for legitimate communication delivery from sources that might be, but have not yet been approved by the recipient.

A CAS according to the present invention may also be employed to purchase products or services. For example, in order to purchase a product from a particular individual or entity (“seller”), the seller would provide an email address to the buyer with instructions to include a request for the purchase of the desired item. Upon receipt of the email, the CAS would auto-generate a response to the email purchase request with instructions for payment of the purchase price. Upon completion of such payment, by using, for example, a credit card number or Pay Pal account, the order is forwarded to the intended recipient for filling of the order. Thus, the form of communication according to the present invention may be in the form of a purchase request. In such instances, the codes can be linked to transact multiple sales, payments, etc. The CAS can use hierarchical control to transact business using the codes. Thus, any information organized in a manner that can be read by the hierarchical control is considered a code within the present invention.

Another aspect of the CAS of the present invention is the ability to provide sorting and filtering mechanisms. For example, because a user may have many valid authorization codes at any particular time, the CAS can be directed to take action on specific authorization codes, or types of authorization codes. Thus, the receiver can use CAS to take specific actions with communications that are received having selected authorization codes, other than directing these communications to an inbox.

Unlike the challenge-response systems known in the art, the present invention allows a user recipient to sign up for a user group using his or her email address and a code. Those emailing to the group will be including such codes for each member of the group, and thus the authorization process will be unnecessary for each member. Such email will go through based on the type of code included in the email when the recipient signed onto the user group. Thus, the user recipient has ultimate control to not receive email from this group later by changing the code or the type of code. Comparatively, in a challenge response system, everyone on the group list must verify the email of everyone else on the list who belongs to this system.

When considering the ways in which the present invention can be used, it is important to not lose sight of the ability of the present invention to operate transparently for the receiver, and for the sender once an authorization code has been obtained. Thus, the present invention is capable of providing an automated solution that will free the receiver from the cumbersome burden of dealing with unsolicited communications.

### BRIEF DESCRIPTION OF THE DRAWINGS

The foregoing summary, as well as the following detailed description of the illustrated embodiments is better understood when read in conjunction with the appended drawings. For the purpose of illustrating the invention, there is shown in the drawings several exemplary embodiments which illustrate what is currently considered to be the best mode for carrying out the invention, it being understood, however, that the invention is not limited to the specific methods and instruments disclosed. In the drawings:

FIGS. 1A and 1B are schematic block diagrams of a first embodiment of a communication authorization system (“CAS”) in accordance with the principles of the present invention;

FIG. 1C is a schematic block diagram of an alternate method for providing an authorization code in accordance with the principles of the present invention.

FIG. 2 is a schematic block diagram of a method of changing authorization codes in accordance with the principles of the present invention;

FIG. 3 is a schematic diagram of a second embodiment of a CAS in accordance with the principles of the present invention;

FIG. 4 is a schematic diagram of a categorization of authorization codes in accordance with the principles of the present invention;

FIG. 5 is a schematic block diagram of a third embodiment of a CAS in accordance with the principles of the present invention;

FIG. 6 is a schematic block diagram of a fourth embodiment of a CAS in accordance with the principles of the present invention;

FIG. 7 is a schematic block diagram of a fifth embodiment of a CAS in accordance with the principles of the present invention;

FIG. 8 is a schematic block diagram of a method of obtaining an authorization code in accordance with the principles of the present invention;

FIG. 9 is a schematic block diagram of a sixth embodiment of a CAS in accordance with the principles of the present invention;

FIG. 10 is a schematic block diagram of a seventh embodiment of a CAS in accordance with the principles of the present invention; and

FIG. 11 is a schematic block diagram of an eighth embodiment of a CAS in accordance with the principles of the present invention.

### DETAILED DESCRIPTION OF THE ILLUSTRATED EMBODIMENTS

The following illustrated examples demonstrate what is believed to be the best mode of the invention through specific implementations of a communication authorization system (“CAS”). These examples, however, are not intended to be exhaustive, but rather illustrative and are therefore not intended to in any way limit the scope of the claims. Accordingly, a CAS is provided to selectively limit communications between a sender and receiver using communication equipment that enables communication between and among the sender and recipient through use of various authorization codes. The CAS may be contained within the communication equipment itself as firmware or software or made available to the intended recipient or the owner of the recipient's communication equipment in the form of firmware or software. Further, the CAS system may be maintained by a third party system separate from the specific communication equipment used by the parties engaged in communication.

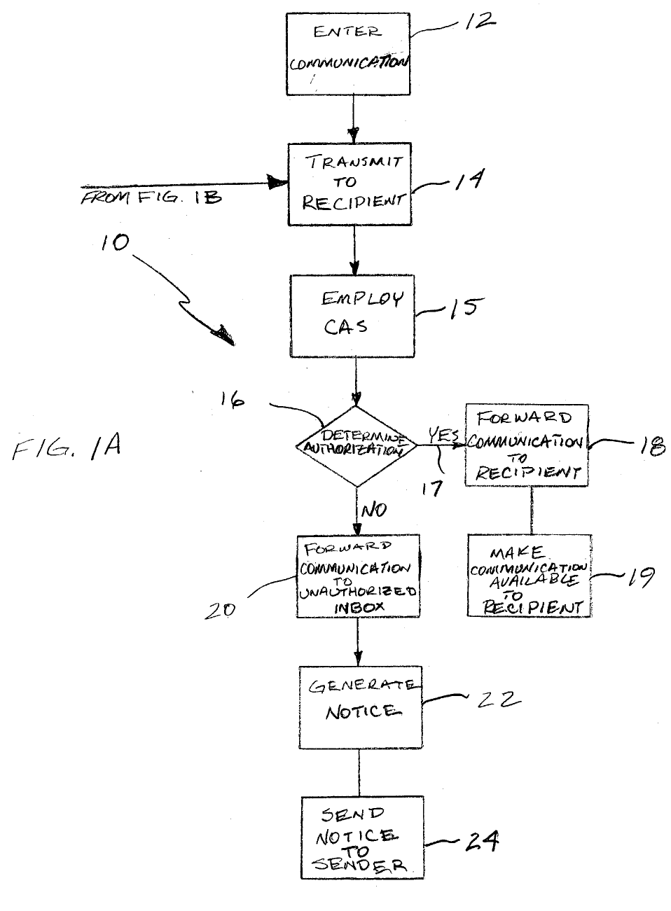

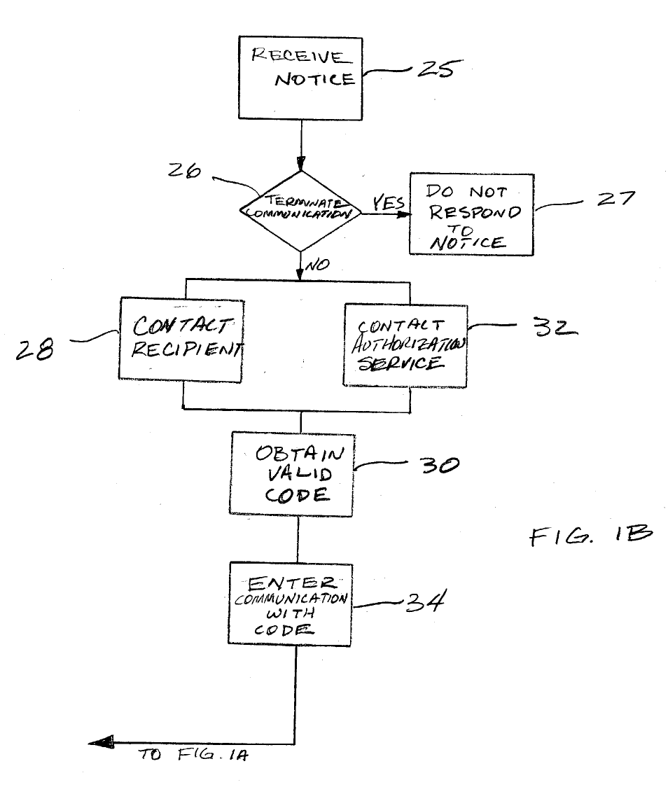

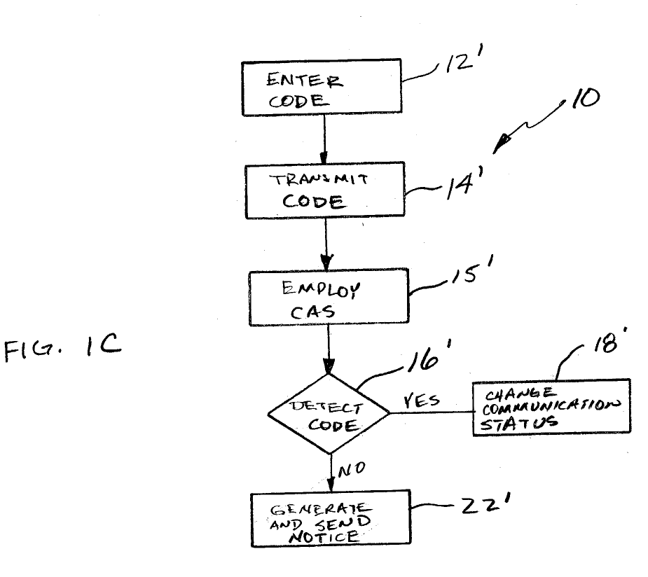

As illustrated in FIG. 1A, in accordance with the principles of the present invention, a communication authorization system (“CAS”), generally indicated at 10, includes the following steps: The sender uses the sender's equipment to enter 12 a desired communication and transmit 14 a desired communication to an intended recipient (or group of intended recipients as the case may be). The communication is sent by the sender's communication equipment to the receiver's communication equipment. Upon receipt of the communication, the receiver's communication equipment employs CAS 15 to determine 16 whether the communication is authorized or unauthorized. If the communication is authorized 17, the communication is forwarded 18 to the intended recipient where it becomes available 19 to the intended recipient for viewing or listening. As will be explained in more detail, such incoming communications could be sorted or categorized into various inboxes based upon the code received with the particular communication. For example, putting some into different boxes based on the codes. If, on the other hand, the communication is determined 16 to be an unauthorized communication, the communication is forwarded 20 to an unauthorized communication box pending receipt of a proper authorization code for that particular communication. When such a potentially unsolicited communication is received, the CAS 10 generates 22 an authorization code notice and sends 24 the notice to the originator or the communication or sender. If the return address is forged, the authorization is automatically terminated since the sender will not receive the notice and the email will not reach the receivers inbox.

As further illustrated in FIG. 1B, upon receipt 25 of the notice, the sender may terminate 26 the transmission of the communication by not responding 27 to the notice; contact 28 the intended recipient via non-system communication to obtain 30 a proper authorization code; or contact 32 a notification/authorization service via the user interface to obtain 30 a proper authorization code pursuant to instructions provided in the authorization code notification. After obtaining the authorization code, the sender can then transmit 14 the communication to the intended recipient with the proper authorization code in a form instructed by the notification service of the CAS. The message is routed from the sender to the recipient through whatever technology is used for the particular type of communication equipment employed by the sender and receiver (e.g., computers with network or Internet connections and access to email servers). Likewise, since a CAS 10 holds the unauthorized communication in an unauthorized inbox 20, the sender could simply enter 12′ and transmit 14′ the authorization code, to change the status of a communication from unauthorized to authorized. The CAS would be employed 15′ to detect 16′ the presence of the code and change 18′ the status of the communication from unauthorized to authorized. If an invalid code is again received, the CAS could simply generate 22′ another notice and send it to the sender. Accordingly, it would not be necessary to resend the entire communication. The advantage to such changing of status would be that it would not be necessary to resend a large email, saving network bandwidth and storage.

Once received, the CAS is again employed 15 to determine whether a valid authorization code is detected. If so, the communication is forwarded 18 to the intended recipient and made available 19 for retrieval by the recipient. Of course, the CAS 10 may be used by only the recipient or by both the sender and recipient. If both sender and receiver use a CAS according to the present invention, it is possible for the authorization notices to bounce back and forth between sender and recipient. As such, the CAS 10 is able to recognize a bounced back email (for example, by tying the authorization notice to the sender's email address). In addition, the CAS 10 could allow the sender to recognize an email from a CAS system stating an authorization process is necessary.

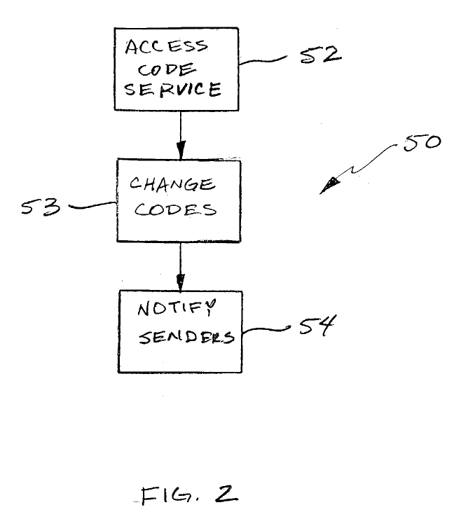

As illustrated in FIG. 2, a CAS in accordance with the principles of the present invention provides a method of changing authorization codes, generally indicated at 50. The user recipient can change authorization codes at any time by accessing 52 an authorization code service via an authorization code user interface, such as a computer or telephone. Changing of authorization codes will make a spammer's mailing list of no value if the spammer purchases any CAS addresses. This will mean that spammers will be unwilling to pay for CAS email addresses because the value of the list can be instantly lost. The user can then change 53 his or her personal authorization codes as desired. The user recipient can also change the nature of the code, e.g. to single use, general, restricted, or move any sender to an exclusion list or a black list (i.e., a list of senders from whom no email will be accepted by the system). The exclusion list or a black list can be based on a set of rules such as what is in a particular field, what domain an email is coming from and may be coupled with the authorization code.

Once a particular authorization code has been changed, the user may notify 54 any affected senders of the new authorization code by sending 55 the new authorization codes to the affected senders with the same communication equipment used to send and receive communications or even a means of communication outside the CAS 50, such as a telephone call. Likewise, the process may simply end after the codes are changed when notification of affected senders is not necessary or desired.

As previously discussed, a CAS, in accordance with the principles of the present invention, while having applicability to many forms of electronic communication, has particular utility with regard to sending and receiving of electronic mail (“email”). Thus, a CAS may be employed with any email system on any system known in the art including computers and other electronic devices and software that can produce, receive, store, print, read, dictate or display email. Likewise the CAS may be incorporated into any communication technology associated with the transmission of email, including, but not limited to, computers, software, email programs, browsers, mail servers, web based mail programs, Internet servers and the Internet.

Because of the nature of email being a digital form of communication, email is adaptable to contain an authorization code embedded somewhere in the email communication that can be easily identified by the CAS to allow a properly authorized communication to pass through the CAS to the intended recipient. The authorization code may be provided in all or a part of the email address, in the subject line of the email or in various other fields of an email, such as the cc: or bc: field of the email, in a new field which may be added to the email specifically to carry an authorization code, anywhere in the body of the email itself, in an authorization code attachment file, or in an authorization code encrypted attachment file.

Of course, as previously discussed, a CAS according to the principles of the present invention may include various types of authorization codes for both internal email and incoming email that is external to a particular corporation, organization or entity. Accordingly, a particular authorization code or group of authorization codes may be reserved for internal use by organizations to manage, sort and distribute email by its members and/or employees. Likewise, various authorization codes may be used solely for external communications to manage the receipt of email by senders outside the receiver's organization. Furthermore, codes could be added to represent purchases, transaction types, products, services or have their meanings defined by the operator or user of the CAS.

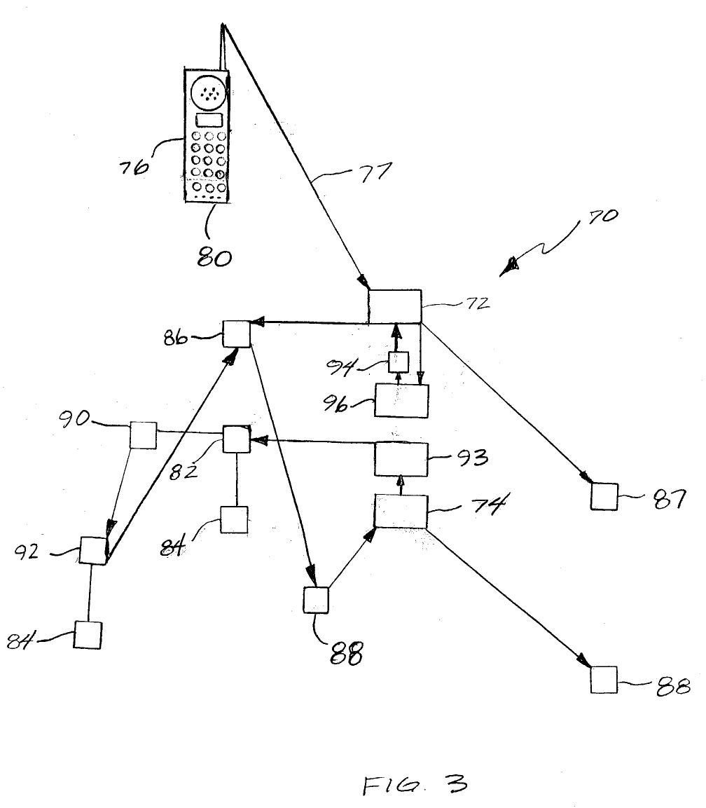

As shown in FIG. 3, a CAS, generally indicated at 70, according to the present invention, configured for use by a particular organization, includes an authorization code system 72 that maintains, administers and transmits the authorization codes. In addition, the CAS includes a verification system 74 for verifying incoming authorization codes by checking incoming communications for a proper authorization code. The verification system 74 may also be employed to sort communications into authorized and unauthorized communications and, when appropriate, transmit an authorization code notice to the sender of an unauthorized communication to allow the sender the ability to obtain a proper authorization code. The CAS 70 may communicate via the Internet, by local area network or wide area network, and may be housed on the same server with the mail server.

The CAS 70 is provided with an authorization code user interface 76 to allow access 77 to the authorization code system 72 to obtain an authorization code. The user interface 76 may be in the form of a telephone 80 in which the sender must call a telephone number, which may or may not be toll free, that will be answered by a server. A notice 82 transmitted to the sender when a message containing an invalid or missing authorization code is received informs the sender that an authorization code is required. The notice 82 instructs the sender to call the authorization code system 72 telephone number and enter a mailbox number and password provided in the notice 82 when prompted to obtain a valid authorization code. By entering the specific mailbox number and password, for example, the authorization code system 72 will generate and provide an authorization code 86 with instructions on how to insert the authorization code into the email so that the verification system 74 will recognize the presence of a valid authorization code. Likewise, the notice 82 could provide instruction on proper code placement. The authorization code system 72 may also require the sender to accept specific usage terms 84 for use of the authorization code. Such usage terms 84 may include, for example, a required fee, which could be paid by credit card, Pay Pal, or other forms of payment options known in the art by providing a form to the sender for completion of a payment transaction before providing the authorization code. The authorization code system 72 could also request a notice 87 to the receiver alerting the receiver to the issuance of an authorization code 86. In order to send the email 88, the sender will then enter the authorization code 86 into the email 88 as instructed and resend the email 88, which will be received by the verification system 74. The email 88 with then be forwarded to the recipient if the verification system 74 detects a valid authorization code 86. Likewise, as previously shown and described in FIG. 1C, the sender could, in the alternative, have the option of sending the authorization code alone to change the status of the previously sent communication from unauthorized to authorized, moving the communication to the receivers authorized inbox.

Likewise, the sender may obtain the authorization code through a link 90 provided in the notice 82 requested by the authorization code system 72 to the sender when an email containing an improper or missing authorization code is received by the CAS 70. Thus, the notice may provide a hyperlink 90 through which the sender can access a web site 92. The web site 92 will then request a mailbox number and a pin number provided in the notice 82. Upon entering the mailbox number and pin number, the web site 92 will provide a valid authorization code with instructions on its use. The web site 92 can time the delivery of the authorization code and check the IP or MAC address of the user to ensure that a particular computer or system is not obtaining more codes than specified or allowed by the system for any one user. Thus, the CAS 70 may respond to the sender by sending a notice 82 containing a link 90 that allows the sender to obtain a valid authorization code. By accessing the link 90, the sender is directed to an Internet web site 92 that will provide the specific usage terms 84 that the sender must agree to before obtaining and using a valid authorization code 86. Acceptance of such terms 84 may generate a particular authorization code 86 unique to that particular sender.

The usage terms 84 required by the CAS 70 must be accepted by a user before the user can obtain a valid authorization code and will, in most cases, be determined by the particular CAS user, whether that user be an individual or an organization. Such terms may include, for example, that:

1. Users agree to use this system according to the guidelines set forth.

2. Users agree to pay $20,000 per incident for each failure to abide by the terms.

3. Users agree to use the Authorization code to send legitimate email only.

4. Commercial attempts to use communications with the authorization code as a method of advertising is prohibited. (Of course, such terms could allow certain commercial uses of the system where the user recipient chooses to receive specific commercial communications).

5. Chain letters are prohibited.

6. Any other desirable terms.

It may also be advantageous to place the CAS 70 in a jurisdiction that has laws that are more favorable to such usage terms.

If agreement to usage terms 84 is not a major concern of the user of the CAS 70 according to the present invention, then the sender may not be required to accept the usage terms 84 before receiving an authorization code. As an added measure, however, authorization codes may simply be provided upon expiration of a set time period. For example, after sending an email to an intended recipient, a notice 82 could be provided to the sender indicating that a valid authorization code is required in order for the intended recipient to receive the email and also indicating that an authorization code will be sent to the sender in so many seconds. After a set time (e.g., ten, thirty or sixty seconds), the system will then send the authorization code to the sender with instructions on its use in order for the receiver to receive the email communication. Likewise, after the request for an authorization code is made, a valid authorization code could be provided that only becomes valid after a certain period of time has lapsed (e.g., ten, thirty or sixty seconds). In addition to linking the authorization code to a particular address, the CAS 70 is also capable of linking the authorization codes to a specific IP or MAC address or other hardware or system specific identification. As such, the CAS 70 can track authorization code usage as well as authorization code requests by specific senders rather than by a sender's address, which can be easily altered or forged.

If needed, a central database could be provided to tie the IP address or MAC address to a particular sender. This will allow many authorization processes to exist and disallow a single sender to simultaneously use all of their email addresses to get authorizations. By using a central registry, the process can query if the sender is authorizing the email elsewhere and wait until this process finishes before starting another authorization process. Otherwise, the system could provide a central authorization process to guarantee only one authorization process is occurring at a time for a particular sender.

The CAS 70 includes a notice system 93 that prepares and transmits the authorization notice 82 when the verification system detects an email with an invalid or missing authorization code. An authorization request 94 is sent to the authorization code system 72 by an authorization approval system 96 when an approval for obtaining a code 86 has been accepted. The authorization approval system 96 works in connection with the authorization code system 72 so that when a request for an authorization code from the user interface 76 is received, the approval system 96 can approve issuance of a valid authorization code 86 by the authorization code system 72. The authorization approval can be automatic or dependent upon an authorization approval list. The authorization requests 94 may contain the sender's email address as well as a copy of the original email, if desired.

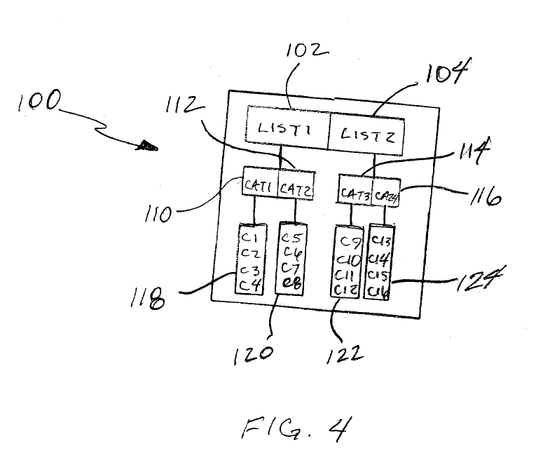

As shown in FIG. 4, a CAS 100 is capable of maintaining certain lists 102 and 104 containing various groups or categories of authorized codes. The codes may then be placed into groups or categories that allow for sorting of incoming email or for particular distribution, e.g. hierarchical distribution, of particular email message dependent upon the authorization code. Thus, in practice, each group or category could be represented by a separate folder or inbox 110, 112, 114 and 116 of the receiver. As messages are received by the CAS 100, the messages are sorted by their respective categories and placed in the appropriate folder or inbox. Such sorting could be advantageous to track emails from shipping providers, certain categories of vendors, etc. Groups 118, 120, 122 and 124 of codes could then be contained within each respective category. Furthermore, the codes themselves could be used to begin the performance of a function, such as to cause the creation of an inbox. Likewise, each message with a specific code may be employed to instruct a particular action to proceed, for example, to perform a sale, charge a credit card, etc.

The CAS 100 also includes folders or mail boxes for receiving and maintaining email messages dependent upon the authorization code provided with the email. Thus, in a simple form, two mail boxes are provided, one for authorized email and one for email containing invalid codes or missing codes. In a more complex form, the code could be used to sort or categorize incoming email messages. Thus, various codes or groups of codes could be created and linked to various inboxes or folders with the CAS. Such codes could include one time codes, hierarchical codes, restricted use codes, sorting codes, miscellaneous codes, etc. As such, more than one sender could be given access to use the same code in order for all email from senders using the same code to be placed in a particular inbox folder. Likewise, different codes could be linked to the same inbox folder so that all email from such codes are placed in a specific inbox folder. In an organizational setting, codes could be used to give senders limited access to persons within an organization based upon their hierarchy within the corporation. Thus, an incoming email could for example be limited to being received by certain levels of receivers and below. Of course, various other schemes and user defined codes could be created for any purpose.

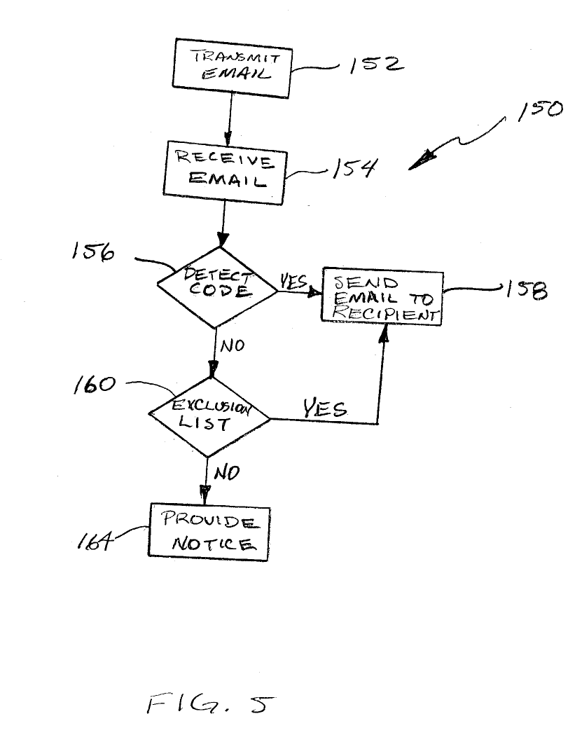

As illustrated in FIG. 5, in order to prevent receipt of unsolicited email, marketing email and other potentially unwanted email in a user's inbox, while retaining the ability to receive important and/or desired communications, to obtain password updates from web sites, and obtain email from service providers when desired, a CAS , generally indicated at 150 according to the present invention, may be incorporated into or added as a pre-receipt verification system to an existing an email system, or applied in conjunction with other virus, spam or security programs. In order for the CAS 150 to operate properly, both the sender and receiver need access to an email account. Any type of email account may benefit and be adapted for use with the CAS 150. The sender transmits 152 a communication to the receiver. Upon receipt 154 of an incoming communication, the CAS 150 will perform one of three functions depending upon whether a valid authorization code has been included in the communication and detected by the CAS. If a valid authorization code is included and detected 156 in the email, the communication will be allowed 158 by the CAS to pass through to the intended recipient. If no authorization code is detected 156, the CAS will determine 160 whether the sender is on an exclusion list by comparing the email address, IP address and/or MAC address of the sender with the same identifying information on the exclusion list. Likewise, the system could provide a “conditional exclusion list” of senders that are not necessarily a part of the general exclusion list, but are in general allowed to email the receiver. The conditional exclusion list could be associated with various user or system defined rules that control when an email is allowed to be authorized.

The existence of such exclusion lists, however, are somewhat risky in that a spammer who obtains an email address in the exclusion list could bypass the CAS 150 by forging the spammer's email address to that of the address contained on the exclusion list. If spam comes from an email address containing a code, the code associated with this email can be changed. Moreover, it is possible with the CAS of the present invention to handle this in several ways. If the person is using a general code, this code can be changed. If the code is tied to this email, then the code can be changed so that only this email is affected. If the email address is on the exclusion list, it can be moved to another list requiring a code. Further, it can be moved to a black list so that this email is always discarded. Such exclusion lists, however, can be relatively easily created and changed to add or remove senders. For example, to create such an exclusion list, a recipient user can send him or herself an email with a specific code that the CAS will recognize as valid. The individual or individuals to be placed on the exclusion list may be inserted into email in the cc: line of the email with a message that the email is being sent to place them on the exclusion list of the user's CAS.

Such a process could be adapted to create any such list for any purpose on any system. For example, a method of copying data into a list would include inserting a list of data into an email, inserting a code into the email, sending the email to a list manager, and using the code to instruct the list manager to extract the list of addresses and insert into a destination list. The list manager can be a database manager, fore example, employed to separate the list of data contained in the email from the email, identify the code or codes contained in the email and perform one or more functions (such as creating an address book from a list of email addresses provided in the email) on the data based upon the code(s) received. The list of data can be entered in one or more of a to: line, a cc: line, a bc: line, a subject line, an attachment or the body of the email.

Referring again to FIG. 5, if the authorization code is missing or an invalid authorization code is detected 156, the CAS 150 will provide notice 164 to the sender that a valid authorization code is required to send email to this particular intended recipient with instructions on obtaining a valid authorization code.

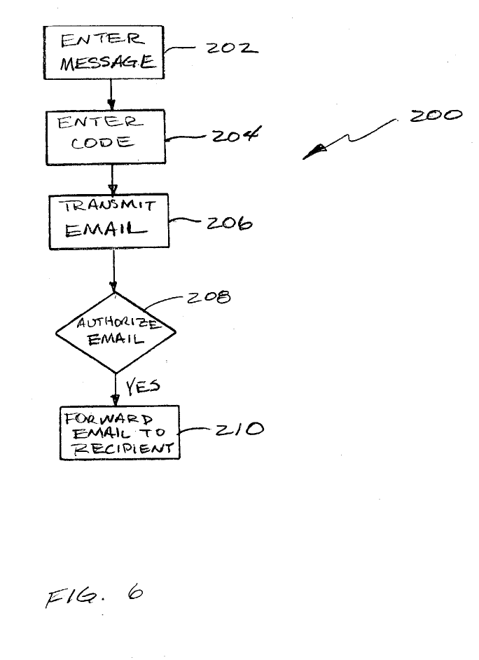

In the event that a sender has permission to transmit a communication to the particular intended receiver and/or has already obtained a valid authorization code, the sender can transmit a communication to a receiver by including the authorization code in the email, such as in the address, subject line, a cc: or bc: line, in the first line of the body of the message itself, for example, or in an attachment to the email. It should be noted that it may be necessary to include various other data (e.g., filler) with the authorization code when used in an encrypted attachment as some encryption systems require files of at least a particular size to encrypt. One advantage of using the code in the email address is that such usage is compatible with existing address book systems and email systems. As shown in FIG. 6, such a method 200 of sending an email to a receiver with a valid authorization code is as follows. The sender enters 202 the communication into the sender's email system. The sender enters 204 the authorization code into the subject line of the email message. The sender transmits 206 the message to the sender. The email communication is transmitted 206 by the sender's computer or other electronic device to the mail server of the sender, across the Internet to the receiver's mail server where the authorization process is performed. The authorization system verifies 208 the authorization code as valid and forwards 210 the communication to the inbox of the intended recipient.

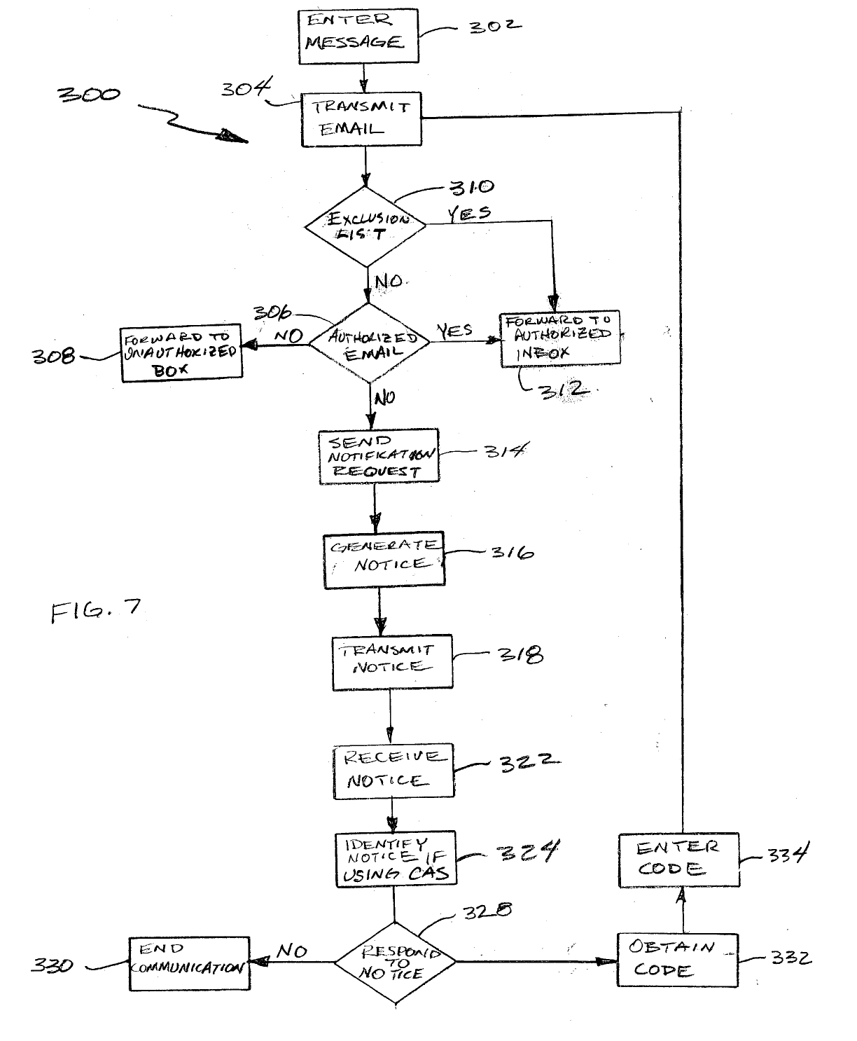

As shown in FIG. 7, a method 300 for blocking unwanted email is provided in which the sender has not obtained a valid authorization code to accompany the email to an intended recipient that is using a CAS according to the principles of the present invention. First, the sender enters 302 the communication into the email system of the sender. The communication is then transmitted 304 to the mail server of the sender, across the Internet and to the receiver's mail server. The authorization system determines 306 whether the communication is authorized, and if not, forwards 308 the communication to an unauthorized communication inbox of the recipient. The unauthorized communication inbox may retain such messages for a set period of time (e.g., day, week, month, etc.) before being deleted or purged in order to allow the intended recipient the opportunity to view such email messages before deletion if desired.

Before the email enters the system, the sender of the email is compared 310 to an exclusion list, which may be maintained by the CAS or outside and independent of the CAS. If the sender of the communication is found to be on the exclusion list, the communication is routed 312 around the authorization system to the receiver's authorized inbox.

If, on the other hand, the sender is not on the exclusion list, the authorization system sends 314 a notification request to the authorization approval system. The authorization approval system then instructs the notice system to generate and send 316 an authorization notice to the sender. The authorization system engages the mail server to transmit 318 an authorization notice to the sender via the Internet to the sender's mail server. In order to verify that the sender's address is real, the authorization system may first “ping” the sender's computer to verify its existence before sending the notice. In the event that the sender is also using a CAS in accordance with the present invention, the sender's authorization process identifies 324 the communication as an authorization notice and forwards 324 the authorization notice to the inbox of the sender. Otherwise, a “ping pong” effect could be created in which authorization notices would be continuously bounced between the sender and receiver. Likewise, the ping ponged response can end up in the unauthorized box or a CAS box. Likewise, the CAS could identify if its own notice is being bounced back by another CAS and simply not respond to any such incoming notices that would otherwise be seen as unauthorized email. In order to prevent spammers from using the notice system described herein from circumventing the CAS, the CAS can check the address of the recipient and therefore verify that the email was previously sent from the recipient before placing any such authorization notice in the inbox. This will effectively prevent the sender from sending out requests for authorization with advertising that gets put into the inbox of a CAS users. Further, if the sender is part of a CAS system, he/she could put an authorization code in the sent email so that the return authorization request contains the code and thus the email gets routed directly to his/her inbox.

Once the sender receives 322 the notice, the sender can simply fail to respond 328 to the notice, thereby stopping 330 the communication from passing through the CAS to the intended receiver. Alternatively, the sender could obtain 332 a valid authorization code by using a non-system communication such as a telephone call to contact an intended recipient to obtain a valid authorization code. The authorization code could then be entered 334 into the email and resent 304 to the recipient. Alternatively, the sender could simply validate the notice itself by returning the notice with the valid authorization code. Once the CAS 300 receives the validated notice, it would simply forward the mail from the sender from the unauthorized box to the authorized box.

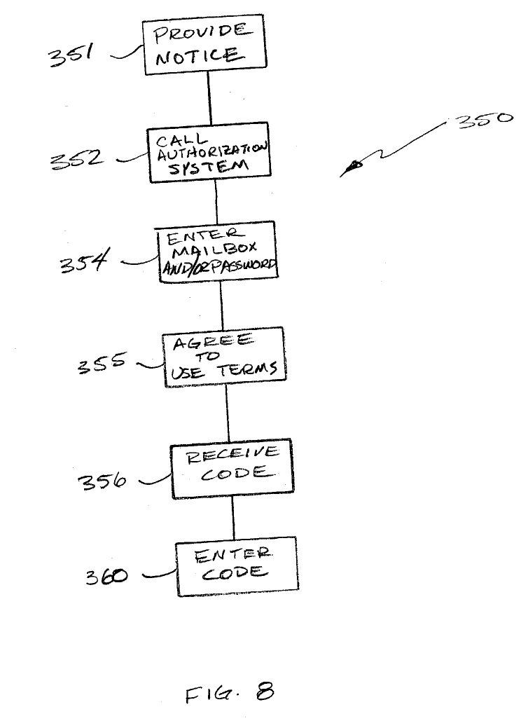

Likewise, as shown in FIG. 8, one method for obtaining an authorization code 350 includes providing 351 an email notice to the sender with instructions for obtaining an authorization code. Such instructions may instructing the sender to call 352 an authorization approval system by dialing a number listed in the notification. The call 352 would then be answered by the authorization approval system and the sender would be prompted to enter 354 the mailbox number and/or password listed in the authorization notification. Because calling such a system creates a cost (either through a toll charge or through a time delay) it would effectively block the wholesale collection of authorization codes. Further, such a system could be automated while still effectively blocking spammers. In addition, incoming calls can be tracked for later usage agreement enforcement.

Once the mailbox and password are entered 354 into the system, the system transmits and the sender would receive 356 the authorization code to the sender. The system could also request that the sender agree to specific terms prior to transmitting a valid authorization code. The sender could agree 355 to such terms by pressing a phone digit, such as zero, in order to accept the terms and receive the authorization code. By entering 360 the authorization code as instructed, the communication will then be received by the intended recipient as an authorized communication in the recipient's inbox as illustrated in FIG. 7. Likewise, as shown in and described with reference to FIG. 1C, the sender could, in the alternative, have the option of sending the authorization code alone to change the status of the previously sent communication from unauthorized to authorized, moving the communication to the receivers authorized inbox.

In order to discourage the exchange of authorization codes between senders or other unauthorized use of authorization codes that could result if a spammer obtains a valid authorization code, the user of a CAS of the present invention may change authorization codes at any time. Changing of authorization codes invalidates all spammer lists that have old codes. The codes can be changed quickly, often and easily. The authorization codes may be changed by accessing the database containing the authorization codes of the recipient. Such authorization codes may be accessed and changed via a web browser, for example, or other user interface known in the art. In addition, by periodically entering new passwords and new mailbox numbers for accessing authorization codes, the system is capable of thwarting auto efforts to obtain authorization codes.

Turning to the nature of the authorization code itself, it should be understood that in a preferred embodiment, the authorization code is dynamic which is an important distinction from the prior art. As implemented, the authorization code of the present invention includes a static portion and a variable portion. The static portion would be the normal email address of the receiver, and would not be changed. The variable portion would be the authorization code obtained by the sender. As is now understood, the authorization code can be changed by the receiver quite often, as circumstances dictate in order to avoid receiving unsolicited communication.

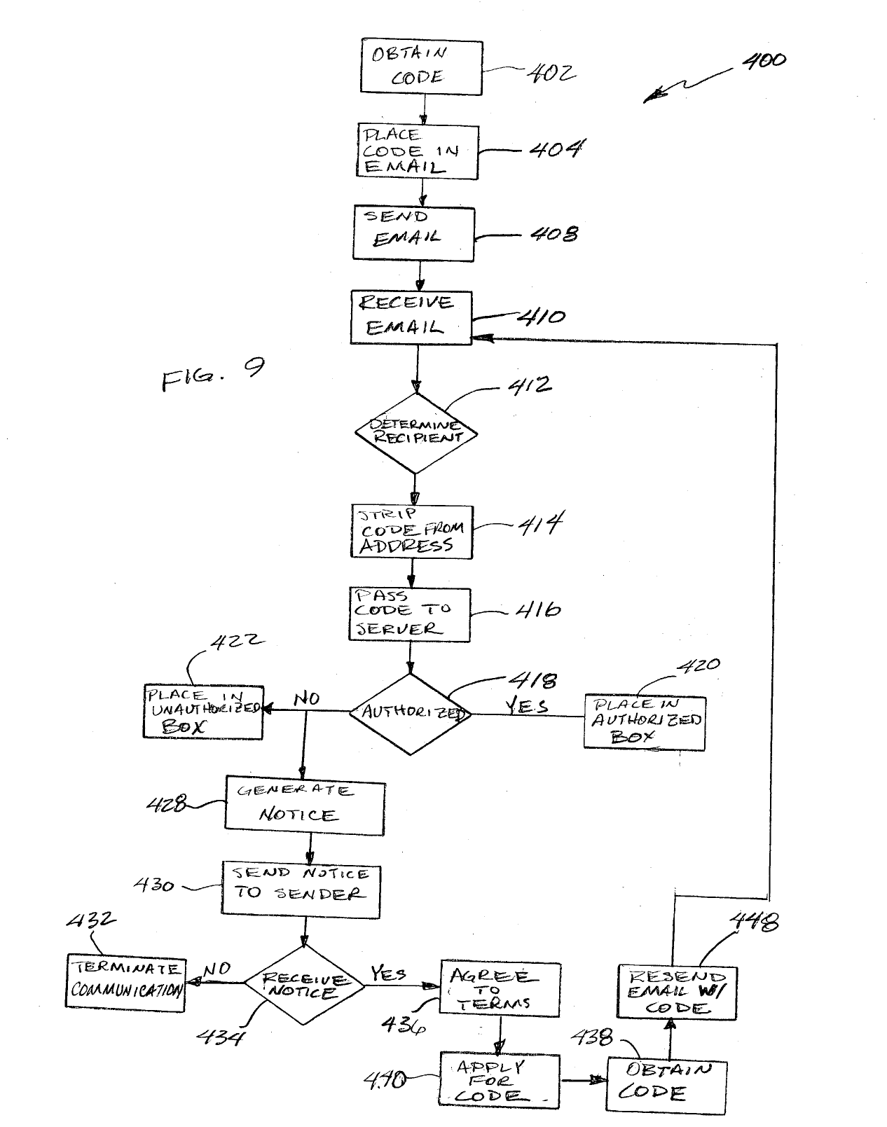

Thus, a CAS, generally indicated at 400, is illustrated in FIG. 9. In this example, the CAS 400 is relatively transparent to the parties sending and receiving email and works with existing email programs and protocols. In addition, the CAS 400 is unique in that the email address of the intended recipient can remain in whole or in part the same as it was before implementing the CAS 400. Moreover, the CAS can fully function without having to know or track the sender's email address. When a sender wishes to send an authorized email to a receiver whose email address is, for example, bob@xyz.com and the sender knows the receiver is a CAS 400 user, the sender can obtain 402 a valid authorization code simply by asking the intended recipient.

Assuming for the moment that the authorization code is “ABC”, and the receiver provides this authorization code to the sender using a non-system communication, for example, through a telephone call or a non-CAS email. The authorization code is placed 404 into the email address of the receiver (e.g., ABC. bob@xyz.com). In addition, the authorization code could e placed in the email address of the user to create a dynamic email address that is compatible with existing email systems. For example, by placing the authorization code in parenthesis, e.g. bob(ABC)@aol.com or (ABC)bob@hotmail.com, the email will pass transparently through AOL's email system along with the code and will be delivered to bob@aol.com. The CAS, however, can be configured to read the code ABC in the address in order to authorize the email in accordance with the principles of the present invention. Of course, there may be other schemes and placement positions for including the authorization code as part or all of the email address of the intended recipient. Thus, placing 404 the authorization code into the email address itself will allow current email communication technologies to use the CAS 400 without any changes to current email communication technologies. Thus, the authorization code is embedded in the email address of the receiver, creating an email address with a static portion (e.g., the standard email address of the receiver) and a variable portion (containing the authorization code). By using such a scheme, each receiver in the CAS 400 could use several authorization codes with each static email address, to allow creation of various groups or categories of sender's based upon usage of common authorization codes among various senders or authorization codes that are grouped into specific categories. The CAS 400 can then track usage of authorization codes by various senders assigned to various authorization codes.

By using a dynamic email address, the sender simply composes the email message, and sends 408 the email to the dynamic email address. The email may be sent, for example, by logging onto the Internet using the sender's computer through an Internet service provider. The Internet transmits the email message to a web-based email service. Of course, the means for placing the email into the Internet network is not important to the present invention, just that the email is transmitted to an email service or system, such as a web-base email service, or some other email server known in the art that will allow the authorization process of the present invention to occur. Once the mail server for the intended recipient receives 410 the email, the mail server will determine 412 that the email is for bob@xyz.com and will strip off 414 the authorization code, ABC. The mail server will pass 416 this code and the address to a database server (the authorization system). The database server matches the email address to the authorization code and determines 418 if the received message is authorized or not. Of course, the code may be incorporated into any part of the email address that will allow the mail server to recognize the static portion of the email address for proper routing of the email address to the intended recipient while allowing the authorization process of the CAS to determine whether a valid authorization code has been received.

Because in this example the sender used a current and valid authorization code for the intended receiver, the email is placed 420 into the “authorized” mailbox of the receiver. Conversely, any mail received without the correct authorization code will be placed 422 into an “unauthorized” mail box. In practice, the database server would simply tag the email message as “authorized” or “unauthorized” using a flag as part of a database record. Once the email is flagged as “authorized,” the email message will be waiting for the receiver to read in the receiver's authorized inbox. Similar to the actions of the sender, the receiver, for example, can connect to the Internet using an Internet service provider and log into a web-based email server. While the web-based service provider and the receiver's Internet service provider can be separate, it should be noted that how the receiver accesses their mail server is not important to the principles of the present invention, only that the receiver has access to his or her email. The web server has access to the database server and gives the receiver access to his or her authorized email messages, including the one sent by the sender. The receiver can then download 426 the email message and the process is complete.

Included in the CAS is the ability for the receiver to manage his or her address book and authorization code(s). The receiver can log onto the mail server and change his or her authorization codes at any time. This may be triggered by receiving an unacceptable number of unwanted email communications. If the mail server also stores the receiver's email contacts, notification of a new authorization code can be automatically generated if desired by the receiver.

Further, if the sender also uses the CAS, the process can proceed seamlessly. For example, a sender receiving an authorization code update can have his or her address book updated automatically. Of course, such automatic updating would not apply if the receiver has not selected an option to automatically reply to emails received from those in his/her address book. In addition, it may be desirable to house the auto update function separately from the address book. That way, the user could maintain names in the address book that the user would not want to send an updated authorization code.

Of course, a primary purpose for the CAS of the present invention is to block unwanted and/or unauthorized email communications from reaching the recipient user of the CAS. The CAS automatically places 422 such unauthorized email communications in an unauthorized mailbox of the recipient. Such a situation may arise if the sender is not aware of the CAS or if he or she has an outdated or incorrect authorization code. Such outdated or incorrect authorization codes may be attempted to be used by senders generating spam email when knowledge of either the correct email address and/or the correct authorization code become known. When the mail server receives 410 an email communication containing an invalid authorization code, the mail server generates 428 a notice email notifying the sender that the receiver is part of the CAS and that an authorization code is required to deliver the sent email. If the sender and receiver are not part of the same intranet, this notice email is sent 430 to the sender through the Internet. If the sender has used an invalid return address (a common tactic used by senders of spam email), the process terminates 432 since the sender never receives notice 434 of the required authorization code, and, consequently, the receiver never receives the spam email in their authorized mailbox. If the return address is a valid address for the sender, the sender is given the opportunity to obtain 438 a valid authorization code by agreeing 436 to certain specific usage terms. Once agreeing to such terms, the sender is given instructions to obtain 438 an authorization code. The usage terms can be emailed directly to the sender and accepted by clicking on an embedded link in the email. Likewise, the sender can be directed to a web-based email server where he or she has to agree to the usage terms online. Of course, various other methods of providing such usage terms to the sender known in the art can be utilized. If the sender knows the receiver and/or has an alternative means of communicating with the receiver, the sender can contact the receiver directly and obtain an authorization code through a non-CAS process, thereby bypassing such usage terms.

Once the sender agrees 436 to the usage terms, in one embodiment of the present invention, the sender is instructed 440 to apply for a valid code by calling into a telephone application service that has access to and can provide a valid authorization code. This system can be automated or operator-based. Further, actual revenue can be generated by the telephone call itself by making the telephone call a toll-based call. Even a small charge could discourage most spam senders. Likewise, the user could be required to access a web site that directs them to pay by credit card for a valid authorization code. Thus, the system could also require a fee for obtaining a valid authorization code for a particular recipient. Such fees could be relatively small in order to discourage spamming or rather significant if the intended receiver is someone of importance that would warrant payment of such fees in order to get a message to that particular recipient. In addition, the system may only allow access to a single authorization code for each telephone call, thus making access to the receiver through email more inconvenient to spammers. Upon completion of the application process, the sender receives the authorization code and resends 448 the email with this code. Because the email will be recognized 418 by the CAS as containing a valid authorization code, the email will be placed 420 in the receiver's authorized mailbox where the receiver will have access to the sent email. As previously discussed, the system can also be configured to simply receive the code (independent of the email message) and move the email currently in the unauthorized box 422 to the authorized box 420.

Use of such authorization codes may be used in a manner that allows the recipient user of the CAS according to the present invention additional control over, not only the receipt of email, but over who can send email to the user recipient and can set limits on the amount of email received. That is, the user recipient or the CAS can provide authorization codes that have restricted use. Thus, it is possible to generate an authorization code that is valid only for use with a single email. For example, instead of the mail server receiving an unauthorized email and placing it into the unauthorized box of the receiver while proceeding to transmit to the sender an authorization code so that the sender can send authorized email according to the usage terms of the CAS, the mail server could simply generate an authorization code valid for only the current email sent to mail server. In the case of a web-based email service, the sender could log onto the email service, enter the single-use authorization code and have the message transferred from the “unauthorized” mailbox to the “authorized” mailbox. In this case, for each email message, the sender would have to enter in a new authorization code. In addition, the CAS could provide an authorization code valid only for a particular time period, or an authorization code that becomes invalid if the sender exceeds the receiver's applied usage terms (e.g., email under a particular size, or only so many email per day or in total from the sender). Likewise, as previously discussed, the authorization code can be linked to a particular sender.

The use of web-based email services, in conjunction with a CAS according to the principles of the present invention, have the added conveniences of automatically notifying those within the address book of the receiver (contained within the database of the mail server) of any change(s) to the receiver's authorization code(s). In addition, users of a CAS who use web-based services can have their codes updated automatically and without user intervention. Of course, it is possible to use a CAS with conventional application-based email services as well. With application-based email services, the sender could manually maintain their email and authorization codes or the application could be modified to do it automatically.

A CAS of the present invention may also be utilized with a conventional ISP. If the receiver uses a conventional ISP, for example, the ISP itself can implement CAS. In such a case, the ISP would implement an authorization code notification service. Further, it is even possible for CAS to exist as an application resident within a conventional email program like Microsoft™ Outlook™. The CAS can exist as a “plug-in” to such an application to filter email and manage authorization codes. Further, the CAS can be implemented to exist anywhere in between the sender and the receiver. For example, the system can be implemented in firmware within a firewall, or written as a firewall program running on the recipient's computer. Retrieving an authorization code could be through a non-system communication or the email program, such as Outlook, and could create a one time code. Likewise, a button could be added to the user's software to generate codes, or a web-based program, such as Hotmail, could be modified to include a code generation button. The receiver could generate new codes by simply accessing their email program or web-based email system, as the case may be and clicking the code generation button. In addition, receivers could view and change their list of codes by simply accessing the database of their codes through their particular user interface. Further, a receiver can opt to generate restricted use authorization codes for those senders not using non-system communications.

The authorization codes of the present invention can be incorporated anywhere in the email message or even separate and apart from the email message. Placing an authorization code into the actual address of the email message, however, makes altering existing email systems to handle CAS simple.

Further it allows senders to maintain authorization codes within current address books. Authorization codes according to the present invention, however, can be placed into the subject line, cc: line, or bc: line, into the actual message, or placed within an attachment to the email. It is also contemplated that the there could be a single authorization code for each email, multiple authorization codes per email (as may be desirable if the authorization codes are used to perform multiple simultaneous functions, such as sorting and/or distribution). In the case of multiple codes per email, such codes could be placed in various locations within the email, either together or in separate locations. Moreover, a single authorization code could be split into different components with the various components used to direct the system to perform various functions, such as sorting and/or distribution. For example, a portion of the authorization code could be used to direct the system to place the email in a particular folder of the recipient, while another portion of the code could be used to direct the system to distribute the email to various other persons within an organization. Further, it is possible to separate the authorization code from the email altogether. With a restricted use authorization code, it is possible to generate a single-use code that is relayed to the sender so that the sender can authorize the email. In such a case, the sender will receive an authorization code from CAS and can then log onto the web server of using CAS and enter the authorization code. The email would then simply be updated or changed to an authorized status. Such single use codes can also be useful when a receiver wishes to receive information on a product, for example, without being put on an advertising list, or when ordering a product and wants to receive an order confirmation but no further email from the vendor.

A CAS according to the present invention also allows encryption to be a part of the authorization process. With a web-based service, such encryption is simply a matter of using secure socket layers to ensure communication from the sender to the receiver. Further, the email message can be encrypted using a public key of either the authorization code system or the receiver and decrypted at the appropriate point in the process. Further, it is possible to make the authorization code secure by placing it in a randomly-generated attachment and encrypting it. The code can be placed in a random location in the attachment. Thus, a sender attempting to generate an authorized attachment would have to generate too many copies of the email to make the process viable.

A CAS according to the present invention also allows the receiver to manage who receives which authorization code(s). Thus, it is possible for the receiver to use different authorization codes for different senders and manage these on the database server of the web server or other system server. Use of different codes for different purposes, however, will allow the user recipient to maintain varying levels of control over incoming email. For example, a user of the CAS could establish:

1. A code that restricts an sender to a limited number of email messages over a specified period of time.

2. A code that restricts the size of an email sent from a sender.

3. A code that directs any attachments to be stripped before message delivery.

4. A code that directs the authorization code system to deliver to the sender a message asking to be put on a “do not email” list as outlined in the authorization code usage terms. Once such a “do not email” notice has been provided, the CAS could monitor any further incoming messages from the sender and send notice of a violation of the usage terms back to the sender and record such violations.

5. A code that creates a process within the CAS system, such as the processing of a credit card transaction.

Other miscellaneous authorization codes may be used by a user recipient of a CAS according to the present invention. Such miscellaneous authorization codes can facilitate the sorting of email into categories chosen and/or defined by the receiver, the sender or the CAS. Such sorting could include the placement of certain predefined categories of codes or certain codes into separate folders. In a web-based CAS system, it would be a simple matter for the ISP of the receiver to categorize the received email message according the authorization code. When the receiver logs on to receive mail, he or she can see what types of mail he or she has received and proceed to read it in the order best suited for him or her.

Email messages viewed by the receiver, whether authorized or not, can be easily changed in status. For example, a CAS according to the present invention may choose to embed controls or links in the messages viewed by the receiver to perform a function. A link may quickly change the status of a message from authorized to unauthorized. With the additional potential of miscellaneous authorization codes, many functions of control are possible.

Another type or category of authorization code according to the present invention is the administrator authorization code. The administrator authorization code can set up specific hierarchical control over email within an organization. Such a code could be used by an organization using CAS on an intranet or internal network. Hierarchical control can dictate activities on multiple codes for multiple purposes. In such an instance, the receiver and sender may be independently within the organization or outside of the organization. An administrator code can set up specific authorization codes to allow or disallow communication between the sender and receiver. For example, the administrator authorization code can set up a hierarchical configuration as to what permissions a sender has to send a message to a particular receiver within the organization or outside the organization if the sender is internal. Furthermore, permissions could be set up for what messages can be received by the receiver and from whom in the hierarchy of the organization. Having such control can allow, for example, messages coming to a company executive to be routed to a secretary if the message does not have authorization to be received directly by the executive. In addition, email by employees could be restricted to business mail only. Using the hierarchical control set up on the authorization system along with the various miscellaneous, internal and external authorization codes will provide a rich authorization scheme to suit many purposes and environments.

An authorization approval system according to the principles of the present invention can be configured to use many different electronic communication technologies. The authorization approval system is not restricted to web-based services since it is possible for the authorization approval system to be located on a telephone-based answering service where its purpose is to allow only qualified users to connect to the user. It is also possible for the authorization approval system to be based on “instant messenger” applications where its purpose is to authorize only certain users of this service to contact the intended receiver. It is also possible for a combination of these communication technologies to host the authorization approval system, for example a web-based internet telephone service that accepts only those calls or messages authorized through a CAS.

When a receiver wants to allow all email from a particular sender to be authorized, the receiver can exempt a sender from having to use a code to ensure that any email sent is automatically authorized. Such exclusion from the CAS also excludes such senders from agreeing to usage terms. The requirement of non-excluded senders, however, to agree to various usage terms may play a significant role in deterring spam. For example, the mail server can be located in a jurisdiction in which violation of the authorization code usage terms may result in substantial penalties. In both web-based email services and application based email systems, the ability to receive an authorization code could require the sender to agree to various usage terms. In the case of web-based systems, both the email and the terms can pass through an email server that is physically located where local or regional laws favor the enforcement of such usage terms. In addition, multiple violations of the terms regarding misuse of a CAS according to the present invention could result in class-action lawsuits being filed against the sender. A database server could record and store each instance of a violation of the usage terms. It is further contemplated that substantial penalties could be structured into the usage terms, as well as agreements that the sender will maintain “‘do not email” lists as is the case for telephone solicitors.

The receiver may be allowed access to the unauthorized communication inbox for specific purposes. Allowing the receiver to have limited access to unauthorized mail will allow the receiver to retrieve information lost by the receiver and transmitted by the sender. For example, a password lost at a particular site can frequently be retrieved through email. This email most likely will arrive and be deemed unauthorized. Without some access to the unauthorized communication inbox, the receiver may not have an easy means of retrieving such lost passwords.

The unauthorized communication inbox may be purged at predetermined intervals decided by the receiver, CAS, or one of its components. Periodically purging the unauthorized box will lessen the likelihood that unauthorized email will be read by the receiver at a high enough rate that spamming from a sender will become cost effective.

The CAS may also provide “spam box notification.” As such, the recipient is notified of those who have appeared in the unauthorized box during a certain period of time (e.g. daily). This notification provides a summary of emails for easy perusal, such as sender email and subject. This process has an advantage over systems that do not store discarded email. It allows the recipient to quickly peruse his/her unauthorized box without having to transfer a lot of data (e.g., messages and attachments).

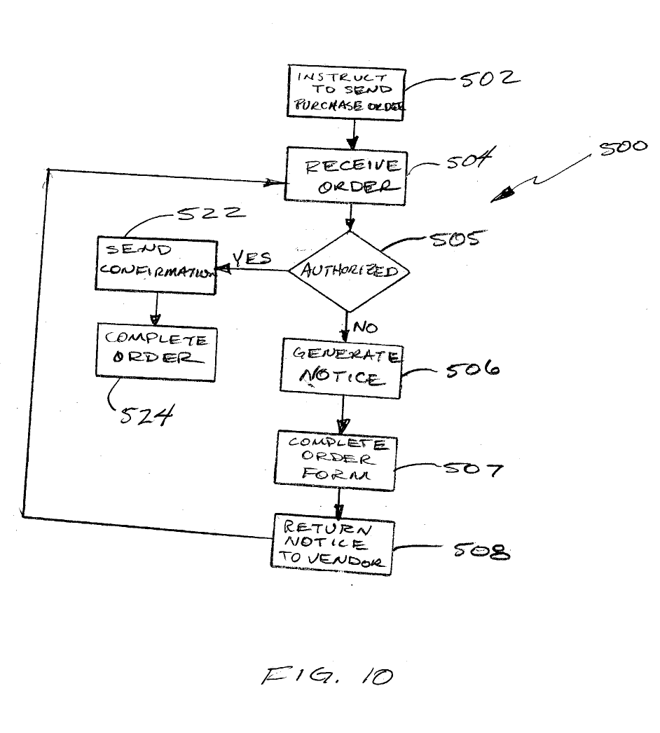

A CAS, generally indicated at 500, according to the principles of the present invention could also be employed for making purchases as illustrated in FIG. 10. A person interested in making a purchase of a product or service would be instructed 502 to send an email to the vendor of such a product or service. The original email could contain such information as the product being purchased and the desired quantity. Upon receipt 504 of the order email, the CAS 500 would determine whether the order contains a valid authorization code, and if not, generate 506 a notice email containing confirmation of inventory of the desired product, based upon the information in the incoming email, with a request for means of payment and an authorization code for returning the email with the requested payment and shipping information. Thus, a credit card form could be provided in the notice along with a form to request a shipping address and other purchase information as is customary in the art. Once the purchaser completes 507 the required information, the notice can be returned to the vendor by simply sending 508 the notice back as a reply. Thus, the notice could be preset with the authorization code already properly included in the email. Likewise, the authorization code could be included in the notice with instructions to the purchaser on placement of the code in the return email. Likewise, the purchaser could be directed to a secure web site in order to complete the purchase. Once the system receives 504 the completed order, the system sends 522 an order confirmation back to the purchaser and the purchase order is complete 524. This process also creates a “paper trail” for commerce transacted over the net.

Another commercial use of a CAS according to the principles of the present invention provides that an authorization code is combined with a rule or another code within an email to perform a function other than simple authorization. For example, if a user receiver requests a set of flights from an airline. The airline (e.g., airline.com) sends the receiver an email with a code identifying our information in the email (e.g., (xyz)airline.com). The email from the airline provides a selection of tickets and options the receiver can buy (e.g., Flight 997 SLC to Portland at 9:50 am, $550; Flight 998 SLC to Portland at 11:20 am $450; etc.) as well as purchase options. Codes can be embedded in the email to select the ecommerce option (e.g. which ticket to purchase or reserve) as well as the payment option. Replying to the email sends information to one or more merchants to complete or further the transaction (e.g. buy flight 998 and send the payment option to the receiver's selected credit card). As such, the codes passed between the email recipient's server as both authorization codes and transaction verification and selection codes.

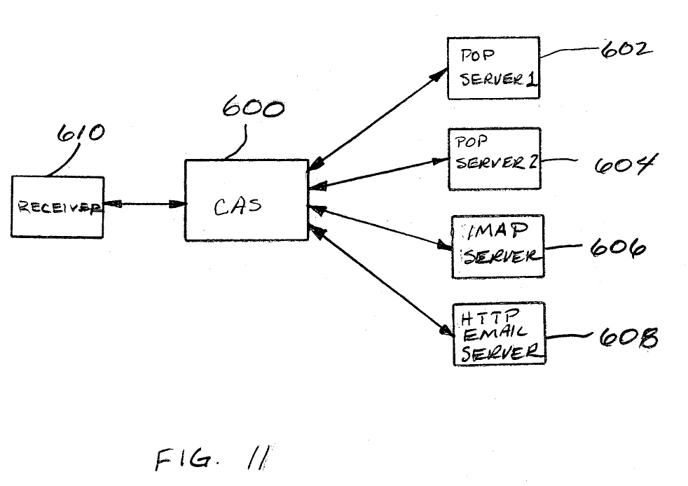

As illustrated in FIG. 11, a CAS 600, in accordance with the principles of the present invention, will actively retrieve email and perform an authorization process. The CAS can actively retrieve email from other email servers (of any type), such as POP servers 1 and 2, 602 and 604, respectively, IMAP server 606 and HTTP email server 608 and performs the authorization process. The CAS 600 can reside on a server itself (such as a web-based system like Hotmail™ which allows the receiver 610 to retrieve email from other email servers 602, 604, 606 and 608 or within an application such as Microsoft™ Outlook™. Accordingly, all of the email data does not have to pass through the CAS 600, by transferring only summary data through CAS 600 to the receiver 610. Thus, the CAS may be located anywhere and does not require any attachment to the email system of the user.

While the methods of the CAS of the present invention have been described with reference to certain illustrative embodiments to illustrate what is believed to be the best mode of the invention, it is contemplated that upon review of the present invention, those of skill in the art will appreciate that various modifications and combinations may be made to the present embodiments without departing from the spirit and scope of the invention as recited in the claims. It should also be noted that while the CAS of the present invention has generally been described as an independent program or system, the CAS is compatible with other filtering and anti-spamming systems or programs known in the art. Thus, before or after authorization in the CAS of the present invention, such other existing or future developed filtering systems or programs could by applied. The claims provided herein are intended to cover such modifications and combinations and all equivalents thereof. Reference herein to specific details of the illustrated embodiments is by way of example and not by way of limitation.

What is claimed is:

1. A method of authorizing communications, comprising: receiving a communication from a sender;
detecting if the communication contains a valid authorization code;
maintaining the communication in an unauthorized communication inbox of a receiver if the authorization code is not detected;
notifying the sender if a valid authorization code is not detected with instructions on obtaining a valid authorization code; and
allowing the sender to obtain a valid authorization code to place the communication in an authorized inbox of the receiver.

2. The method of claim 1, further comprising sending the authorization code to the receiver to place the communication from the unauthorized inbox to the authorized inbox.

3. The method of claim 2, wherein said sending the authorization code is sent separately from the communication.

4. The method of claim 1, further comprising resending the communication with the valid authorization code to place the communication in the authorized inbox of the receiver.

5. The method of claim 1, further including forwarding the communication to a recipient if a valid authorization code is detected.

6. The method of claim 1, further including detecting whether the sender is on an exclusion list before detecting if the communication contains a valid authorization code.

7. The method of claim 1, further including allowing the receiver to change at least one authorization code.

8. The method of claim 7, wherein said allowing includes changing the type of the at least one authorization code.

9. The method of claim 7, wherein said changing the type includes changing the at least one authorization code to one of a hierarchical code, a restricted use code, a miscellaneous code, an administrative code, and a limited use code.

10. The method of claim 1, further including forwarding the communication to an unauthorized box if a valid authorization code is not detected.

11. The method of claim 1, further including contacting an intended recipient of the communication to obtain an authorization code.

12. The method of claim 1, further including contacting an authorization code service to obtain a valid authorization code.

13. The method of claim 12, wherein said service is a telephone-based service.

14. The method of claim 12, wherein said service is a network-based service.

15. The method of claim 14, wherein said network-based service is a web-based service.

16. The method of claim 14, wherein said service is provided through email communication.

17. The method of claim 1, wherein said communication is email.

18. The method of claim 1, wherein said authorization code is contained at least in part of an intended recipient's email address.

19. The method of claim 1, wherein said email address comprises a static portion and a variable portion which includes the authorization code.

20. The method of claim 1, wherein said authorization code is placed in any part of the email.

21. The method of claim 1, further including providing a user with the ability to change authorization codes.

22. The method of claim 1, further including requiring the sender to agree to at least one usage term before allowing the sender to obtain a valid authorization code.

23. The method of claim 22, wherein at least one of said detecting, maintaining, notifying and allowing is performed in a jurisdiction having laws particularly favorable to such usage terms.

24. The method of claim 1, further including requiring the sender to pay a fee before allowing the sender to obtain a valid authorization code.

25. The method of claim 1, further including requiring the sender to wait for a predetermined period of time before a valid authorization code can be used.

26. The method of claim 1, further including using said authorization code for at least one of sorting, authorizing, tracking and filing.

27. The method of claim 1, wherein said allowing the sender to obtain a valid authorization code includes requiring the sender to wait for a predetermined period of time before the sender can use the valid authorization code.

28. The method of claim 1, wherein said allowing the sender to obtain a valid authorization code includes limiting the sender to a predetermined to a predetermined number of authorization codes in a predetermined period of time.

29. The method of claim 1, further including linking said authorization code to a specific sender.

30. The method of claim 1, further including tying up a system of the sender for a predetermined period of time specified period of time before allowing the sender to obtain the valid authorization code.

31. A method of preventing email from reaching an inbox of a receiver, comprising:
providing codes to be embedded in an email;
verifying usage of valid codes in each received email message;
limiting access to email messages received without a valid code; and
notifying senders of email messages that have not included a valid code.

32. The method of claim 31, further including using an email address of a user to include the code.

33. The method of claim 32, wherein said email address comprises a static portion and a variable portion which includes the code.

34. The method of claim 31, further including categorizing said codes into various groups.

35. The method of claim 31, further including using the code to create an inbox.

36. The method of claim 34, wherein said categorizing allows for sorting of email.

37. The method of claim 35, wherein said categorizing provides hierarchical access to potential recipients within an organization.

38. The method of claim 35, further including providing separate internal and external codes for restricting email within an organization.

39. The method of claim 31, further including allowing administrative control of said codes.

40. The method of claim 31, wherein said codes comprise restricted use codes, including restrictions on at least one of time and number.

41. The method of claim 31, further including providing access to change codes as desired.

42. The method of claim 31, further including breaking the code into at least two pieces, each piece used for a different purpose.

43. The method of claim 31, further including using various parts of the code for different purposes.

44. The method of claim 32, wherein said email address with the code included is compatible with existing email systems.

45. A method of filling a purchase order, comprising:
receiving an order from a purchaser via email;
determining whether the order is authorized;
sending a notice via email to the purchaser, the notice containing a valid authorization code and a form for paying for a product to be purchased; and
receiving the order form from the purchaser.

46. The method of claim 45, further comprising verifying that the order form is complete.

47. The method of claim 45, further comprising sending a confirmation of the completed order to the purchaser upon receipt of the order form.

48. The method of claim 45, further comprising including confirmation of inventory in the notice.

49. The method of claim 45, filling the order and sending the order to the purchaser upon receipt of a completed order form.

50. A method of limiting email from reaching a receiver, comprising:
receiving an email message from a sender;
checking for an authorization code accompanying the email;
forwarding the email to a receiver's inbox if a valid authorization code is found;
sending a notice to the sender if a valid authorization code is not found, the notice providing instructions on obtaining a valid authorization code; and
allowing the sender to obtain a valid authorization code by following the instructions in the notice.

51. The method of claim 50, wherein said allowing comprises providing an authorization code service for providing authorization codes.

52. The method of claim 51, wherein said authorization code service is a telephone accessible service.

53. The method of claim 51, wherein said authorization code service is a web accessible service.

54. The method of claim 51, wherein said authorization code service requires a fee for obtaining a valid authorization code.

55. The method of claim 51, wherein said authorization code service requires the sender to agree to at least one usage term.

56. The method of claim 50, further including checking if the sender is on an exclusion list if an authorization code is not present and forwarding the email to a receiver's inbox if the sender is on the exclusion list.

57. The method of claim 50, wherein the authorization code is contained in one of the email address, an attachment, the subject line, the cc: line or the bc: line.

58. The method of claim 57, wherein said authorization code is part of the email address of the recipient.

59. The method of claim 58, further comprising stripping the authorization code from the email address to determine if the email is authorized.

60. A method of using codes received by an email system through an email communication, comprising:
obtaining a code;
inserting the code into an email communication;
sending the email communication to a recipient; and
using the code to begin a process external to the email system.

61. The method of claim 60, wherein said process comprises a purchasing process.

62. The method of claim 61, wherein said purchasing process includes a credit card charging process.

63. The method of claim 60, wherein said process comprises sending a purchase request form to a sender.

64. The method of claim 60, wherein said process comprises directing a sender to a secure purchase web page.

65. The method of claim 60, further including breaking the code into at least two pieces, each piece used to begin a different process.

66. The method of claim 60, further including using various parts of the code to begin different processes.

67. A method of distributing email, comprising:
providing at least one code to be embedded in an email address;
verifying usage of said at least one code in a received email message; and
distributing the email message according to the at least one code embedded in the email address.

68. The method of claim 67, further including providing the at least one code for use as the entire user name of the email address.

69. The method of claim 67, further including providing the at least one code for use as a portion of the user name of the email address.

70. The method of claim 67, further including sorting the email message according to the at least one code.

71. The method of claim 67, further including providing a plurality of said codes and categorizing said codes into various groups.

72. The method of claim 71, further including using said plurality of codes to create a plurality of inboxes.

73. The method of claim 71, wherein said categorizing allows for sorting of email.

74. The method of claim 71, wherein said categorizing provides hierarchical access to potential recipients within an organization.

75. The method of claim 67, further including providing separate internal and external codes for restricting email within an organization.

76. The method of claim 67, further including providing codes for administrative control of said distributing.

77. The method of claim 67, wherein said at least one code comprises at least one of a restricted use code.

78. The method of claim 67, further including providing access to change said at least one code.

79. A method of copying data into a list, comprising;
inserting a list of data into an email;
inserting a code into the email;
sending the email to a list manager; and
using the code to instruct the list manager to extract the list of addresses and insert into a destination list.

80. The method of claim 79, wherein the inserting the list of data is entered in at least one of a to: line, a cc: line, a bc: line, a subject line, an attachment and a body of the email.

81. The method of claim 79, wherein the list of data comprises a list of email addresses.
